(19) United States
(12) Patent Application Publication
(10) Pub. No.: US 2015/0077713 A1
(43) Pub. Date: Mar. 19, 2015

(54) METHOD AND PROJECTOR FOR PROJECTING A 3D IMAGE ONTO A PROJECTION SURFACE

(71) Applicant: Jan Oliver Drumm, Homburg (DE)

(72) Inventor: Jan Oliver Drumm, Homburg (DE)

(73) Assignee: OSRAM GmbH, Muenchen (DE)

(21) Appl. No.: 14/376,443

(22) PCT Filed: Feb. 15, 2012
(86) PCT No.: PCT/EP2012/052597

§ 371 Date: Sep. 26, 2014

(51) Int. Cl. G02B 27/26

(52) U.S. Cl. CPC G02B 27/26
USPC 353/8; 353/121; 353/7

(57) ABSTRACT

Various embodiments relate to a method for projecting a 3D image onto a projection surface, which includes a first and a second partial images for a right and left eyes of a first viewer, respectively. A first illumination beam, which has electromagnetic radiation of a predetermined first property, is produced depending on first image data. A second illumination beam, which has electromagnetic radiation of a predetermined second property different from the first property, is produced depending on second image data. The first and the second illumination beam are deflected towards the projection surface such that the first and the second illumination beams produce a first and a second beam spots thereon, respectively. The first and the second beam spots are moved across the projection surface such that the first and the second partial images are shown with the aid of the first and the second beam spot, respectively.

The invention relates to a method for projecting a first 3D image onto a projection surface. The first 3D image includes a first partial image for a right eye of a first viewer of the first 3D image and a second partial image for a left eye of the first viewer of the first 3D image. Furthermore, the invention relates to a projector for projecting the first 3D image onto a projection surface.

In a stereoscopic image projection (also called stereo projection), 3D images or 3D films are presented stereoscopically by projectors suitable therefor. A stereoscopic image projection requires higher technical outlay than a conventional 2D projection with a projector and a white projection screen. The 3D images or 3D films are projected onto a projection surface simultaneously or quasi-simultaneously in partial images for the right and left eyes of a viewer. Therefore, hitherto it has been necessary for the projection system to include at least two conventional projectors or one projector with two objective lenses. In order to recognize the three-dimensional representation, separation of right and left partial images (channel separation) must then be effected in any stereoscopic viewing method. This separation can be effected in different ways and characterizes different projection techniques.

In the case of the polarization filter technique, the channel separation is achieved with polarized light. By way of example, polarizing filter sheets offset by 90° in each case are situated in front of the projection objective lenses. In cinemas, two projectors are also used for this purpose. A viewer views the representation of the 3D images through polarization spectacles having polarizing filters for separating the partial images. The polarizing filters of the polarization spectacles are coordinated with the polarizing filter sheets on the projection objective lenses. A metallically coated projection screen is required for maintaining the polarization status of the light. A normal white projection screen would disperse the light again and the channel separation would be cancelled. Disadvantages include firstly the decrease in light as a result of the filters used and the metallic projection screen, and secondly the fact that, with the use of linearly polarized light, it is necessary to keep the head straight during image viewing. If the head is kept slanted, the angle of 90°, necessary for channel separation, between the sheets in front of the projection lenses and the filters in the spectacles changes. As a result, channel separation is no longer provided and “ghost images” appear. This disadvantage can be avoided by the use of circularly polarized light.

In the Dolby 3D projection method, the partial images of the 3D image are projected with the aid of a broadband radiation source, wherein the 3D image content is split into two partial images via the splitting of the emitted light spectrum or wavelength spectrum into two spectrally independent color spaces. For this purpose, frame by frame, for example a color filter is adjusted from a first position to a second position. The first position spans a different color space in comparison with the second position. The centroid wavelengths of the two color spaces do not overlap. For example, a green, red and/or blue partial image composed of lower (color space A, first color space) and higher (color space B, second color space) wavelengths is projected alternately, for example with a frequency of 144 Hz. Alternatively, it is possible to use two projectors in simultaneous operation which are equipped with filters that generate the two spectrally independent color spaces. The separation of the image channels and of the partial images at the human eye of the viewer takes place by means of filter spectacles having color filters and/or interference filters.

U.S. Pat. No. 6,283,597 B1 discloses a 3D projector including two RGB projectors. The two RGB projectors represent different partial images of a 3D image using two different color spaces on a projection surface. Both RGB projectors each have a plurality of optical elements for beam guiding and beam focusing, for example lenses, prisms, and/or mirrors.

DE 10 2008 063 634 A1 discloses a projector for representing 2D images, wherein the 2D images are projected with the aid of a rapidly moving laser beam onto a projection surface point by point, line by line so rapidly that a viewer sees the 2D images or films consisting of the 2D images on the projection surface. The projector is also designated as a flying-spot projector.

In various embodiments, a method and a projector for projecting a 3D image onto a projection surface are provided which enable a simple, compact and/or cost-effective design of the projector in conjunction with a high image quality and/or low image flicker. Furthermore, in various embodiments, a method and a projector for projecting a 3D image onto a projection surface are provided in which no polarization-maintaining projection surface is required for representing and/or viewing the 3D image.

In various embodiments, a method for projecting a first 3D image onto a projection surface is provided. The first 3D image includes a first partial image for a right eye of a first viewer of the first 3D image and a second partial image for a left eye of the first viewer of the first 3D image. A first illumination beam is generated depending on first image data, which are representative of the first partial image of the first 3D image. The first illumination beam includes electromagnetic radiation having a predefined first property. A second illumination beam is generated depending on second image data, which are representative of the second partial image of the first 3D image. The second illumination beam includes electromagnetic radiation having a predefined second property, which differs from the first property. The first and second illumination beams are deflected toward the projection surface such that the first illumination beam generates a first beam spot on the projection surface and the second illumination beam generates a second beam spot on the projection surface. In this case, the first beam spot is moved over the projection surface such that the first partial image of the first 3D image is represented with the aid of the first beam spot, and the second beam spot is moved over the projection surface such that the second partial image of the first 3D image is represented on the projection surface with the aid of the second beam spot. In the visible range, the electromagnetic radiation can also be designated as illumination radiation and/or the beam spots can also be designated as light spots.

The two partial images show a two-dimensional image from slightly different perspectives, as a result of which a stereoscopic effect arises and the overall image, which is two-dimensional per se, appears to the viewer as a stereoscopic, 3D image. The first 3D image can be e.g. part of a first series of first 3D images that are projected successively onto the projection surface. The first series of first 3D images can be a first 3D film, for example. For this purpose, the two beam spots are guided over the projection surface by the deflection of the illumination beams. The two beam spots are guided over the projection surface line by line and/or in a meandering fashion, for example.

The use of the two illumination beams for representing the first 3D images makes it possible to use at least partly the same optical system and/or the same optical elements for the deflection and/or guidance of the two illumination beams. Furthermore, no color wheel and/or filter wheel are/is required for the projection. This makes it possible to embody a corresponding projector in a compact, simple and/or cost-effective manner. By way of example, the projector can be embodied so compactly that it is easily portable and/or can be integrated for example into a portable device, for example into a cellular phone, a pager or a mobile games console.

The separation of the represented partial images of the first 3D image takes place on the part of the first viewer by means of suitable first filter spectacles having an optical filter for the right eye of the first viewer, said optical filter transmitting the electromagnetic radiation of the first partial image of the first 3D image and/or the electromagnetic radiation having the first property and filtering out the electromagnetic radiation of the second partial image of the first 3D image and/or the electromagnetic radiation having the second property, and having an optical filter for the left eye of the first viewer, said optical filter transmitting the electromagnetic radiation of the second partial image of the first 3D image and/or the electromagnetic radiation having the second property and filtering out the electromagnetic radiation of the first partial image of the first 3D image and/or the electromagnetic radiation having the first property. Furthermore, with the use of electromagnetic radiation in the non-visible range, the filter spectacles can be designed in such a way that the partial images are nevertheless visible to the viewer wearing the filter spectacles.

In various embodiments, colored (that is to say multichromatic) illumination light of a first color space can be used as electromagnetic radiation having the predefined first property and colored illumination light of a second color space can be used as electromagnetic radiation having the predefined second property. In other words, the predefined property is, for example, representative of the color space used. For example, the same or virtually the same colors can be represented with both color spaces (metamerism). By way of example, the same white point can be represented with both color spaces. By way of example, each of the color spaces includes green, red and blue light or, by way of example, each of the color spaces includes amber-colored and dark-blue light, wherein the wavelengths of the colors of the first color space are shifted within a color to the wavelengths of the colors of the second color space. By way of example, identical colors of different color spaces have centroid wavelengths shifted with respect to one another. The separation of the partial images of the 3D image by the use of different color spaces in the representation of the 3D image makes it possible to use a projection surface which is not polarization-maintaining. By way of example, a simple projection screen and/or wall can then be used as the projection surface. The filter spectacles for the first viewer are then designed such that, for the right eye of the viewer, they transmit illumination light of the first color space and filter out the illumination light of the second color space and, for the left eye of the viewer, they transmit illumination light of the second color space and filter out illumination light of the first color space. With the use of electromagnetic radiation in the non-visible range, the color spaces can also be designated as wavelength spaces.

In various embodiments, the first and second color spaces are chosen such that the same white point can be represented with both color spaces. This can contribute to the first viewer being given the impression of seeing colors of a single color space.

In various embodiments, electromagnetic radiation having a first polarization is used as electromagnetic radiation having the predefined first property and electromagnetic radiation having a second polarization is used as electromagnetic radiation having the predefined second property. The filter spectacles for the first viewer are then designed such that they transmit illumination light having the first polarization for the right eye of the viewer and they transmit illumination light having the second polarization for the left eye of the viewer.

The separation of the partial images for the right and left eyes with the aid of different polarization of the two partial images can take place in addition or as an alternative to the separation of the partial images by means of different color spaces. If the separation by means of the polarization takes place in addition to the separation by means of the color spaces, then a selectivity of the partial images can be improved as a result. In other words, the color spaces used can overlap and/or the centroid wavelengths can be closer to one another than in the case of a separation of the partial images exclusively by means of the color spaces. This can contribute to a particularly good color representation. The first filter spectacles are then designed such that, for the right eye of the first viewer, they transmit illumination light of the first color space and having the first polarization and filter out illumination light of the second color space and having the second polarization and, for the left eye of the viewer, they transmit illumination light of the second color space and having the second polarization and filter out illumination light of the first color space and having the first polarization. Furthermore, the first and second properties of the illumination light can relate to further properties of the illumination light which make it possible to separate the partial images of the 3D image.

If the separation of the partial images takes place exclusively by means of the polarization, then the property of the electromagnetic radiation indicates the type of polarization. If the separation of the partial images takes place exclusively by means of the color spaces, then the property of the electromagnetic radiation indicates the wavelength ranges of the color spaces. If the separation of the partial images takes place by means of the color spaces and the polarization, then the property of the electromagnetic radiation indicates the wavelength ranges of the color spaces and the polarization of the electromagnetic radiation.

In various embodiments, the two beam spots are projected onto the projection surface in a manner being superimposed on one another. This contributes to the fact that the same optical system or at least partly the same optical elements can be used for both illumination beams. This can contribute to a compact and/or cost-effective design of the projector.

In various embodiments, during the representation of the first 3D image, a second 3D image is represented on the projection surface. The second 3D image includes a first partial image of the second 3D image for a right eye of a second viewer and a second partial image of the second 3D image for a left eye of the second viewer. For this purpose, a third illumination beam is generated depending on third image data, which are representative of the first partial image of the second 3D image. The third illumination beam includes electromagnetic radiation having a predefined third property, which differs from the first and second properties. A fourth illumination beam is generated depending on fourth image data, which are representative of the second partial image of the second 3D image. The fourth illumination beam includes electromagnetic radiation having a predefined fourth property, which differs from the first, second and third properties. The third and fourth illumination beams are deflected toward the projection surface such that the third illumination beam generates a third beam spot on the projection surface and the fourth illumination beam generates a fourth beam spot on the projection surface. The third beam spot is moved over the projection surface such that the first partial image of the second 3D image is represented with the aid of the third beam spot. The fourth beam spot is moved over the projection surface such that the second partial image of the second 3D image is represented on the projection surface with the aid of the fourth beam spot.

In other words, the second 3D image is represented with the aid of the third and fourth illumination beams, which second 3D image is superimposed on the first 3D image and can be viewed by the second viewer, while the first viewer views the first 3D image. In this way, different image contents can be simultaneously represented in 3D for different viewers. By way of example, on the same projection surface, two viewers can simultaneously see different 3D films or simultaneously play a 3D computer game from different perspectives, the entire projection surface being available to both viewers for their 3D image. The third and fourth properties of the third and fourth illumination beams, respectively, can relate—in a manner corresponding to the first and second properties—to the color space used and thus to the wavelengths of the electromagnetic radiation used and/or to the polarization of the electromagnetic radiation used. Furthermore, with further illumination beams further partial images of further 3D images for further viewers can be represented simultaneously on the same (entire) projection surface.

The separation of the represented partial images of the second 3D image takes place, on the part of the second viewer, by means of suitable second filter spectacles having an optical filter for the right eye of the second viewer, said optical filter transmitting the electromagnetic radiation of the first partial image of the second 3D image and/or the electromagnetic radiation having the third property, and having an optical filter for the left eye of the second viewer, said optical filter transmitting the electromagnetic radiation of the second partial image of the second 3D image and/or the electromagnetic radiation having the fourth property. Furthermore, the optical filter of the second filter spectacles, for the right eye of the second viewer, filters out the electromagnetic radiation of the second partial image of the second 3D image and of both partial images of the first 3D image and/or the electromagnetic radiation having the first, second and fourth properties. Moreover, the optical filter of the second filter spectacles, for the left eye of the second viewer, filters out the electromagnetic radiation of the first partial image of the second 3D image and the electromagnetic radiation of both partial images of the first 3D image and/or the electromagnetic radiation having the first, second and third properties.

In various embodiments, a projector for projecting the first 3D image onto the projection surface includes a first illumination arrangement, which generates the first illumination beam depending on the first image data. The first illumination beam includes electromagnetic radiation having the predefined first property. A second illumination arrangement generates the second illumination beam depending on second image data, which are representative of the second partial image of the first 3D image. The second illumination beam includes electromagnetic radiation having the predefined second property, which differs from the first property. A deflection device deflects the first and second illumination beams towards the projection surface such that the first partial image of the first 3D image can be represented with the aid of the first illumination beam and the second partial image of the first 3D image can be represented with the aid of the second illumination beam on the projection surface.

In various embodiments, the first illumination arrangement is designed for example such that it generates the electromagnetic radiation of the first color space, and the second illumination arrangement is designed such that it generates the electromagnetic radiation of the second color space, which differs from the first color space.

In various embodiments, the first illumination arrangement includes: a first radiation source, which is designed such that it generates electromagnetic radiation in a first wavelength, a second radiation source, which is designed such that it generates electromagnetic radiation in a second wavelength range, a third radiation source, which is designed such that it generates electromagnetic radiation in a third wavelength range. The electromagnetic radiation in the first, second and third wavelength ranges spans the first color space, for example. The second illumination arrangement includes: a fourth radiation source, which is designed such that it generates electromagnetic radiation in a fourth wavelength range, a fifth radiation source, which is designed such that it generates electromagnetic radiation in a fifth wavelength range, and a sixth radiation source, which is designed such that it generates electromagnetic radiation in a sixth wavelength range, wherein the electromagnetic radiation in the fourth, fifth and sixth wavelength ranges spans the second color space, for example.

As an alternative thereto, the first illumination arrangement can include only the first and second radiation sources and the second illumination arrangement can include only the fourth and fifth radiation sources. The electromagnetic radiation in the first wavelength range emitted by the first radiation source and the electromagnetic radiation in the second wavelength range emitted by the second radiation source then span the first color space and the electromagnetic radiation in the fourth wavelength range emitted by the fourth radiation source and the electromagnetic radiation in the fifth wavelength range emitted by the fifth radiation source then span the second color space. Furthermore, in each case two radiation sources of an illumination arrangement can emit electromagnetic radiation of the same color, such that electromagnetic radiation in two wavelength ranges and thus one color space can be generated by an illumination arrangement including three radiation sources.

The individual wavelength ranges can be relatively narrow or relatively wide depending on the radiation source used. By way of example, the wavelength ranges can have a width of between 1 and 10 nm. The wavelength ranges each have a centroid wavelength which lies approximately in the center of the respective wavelength range, for example, and/or at which there is an intensity maximum of the emitted electromagnetic radiation. The different wavelength ranges, for example two wavelength ranges of the same color but of different color spaces, can overlap one another, in which case the centroid wavelengths must respectively have a sufficient spacing relative to one another. The sufficient spacing depends on the selectivity of the filter spectacles used. If the selectivity of the filter spectacles is 5 nm, for example, then different centroid wavelengths of the same color should have a spacing of more than 5 nm relative to one another.

In this application, the fact that electromagnetic radiation, in particular illumination light, has the same color means that the illumination light leaves a viewer with an identical or at least similar color impression. In this context, illumination light of the same color is, for example, green, red or blue. Each individual color can be represented with the aid of illumination light having different wavelengths and/or from different wavelength ranges. By way of example, illumination light in the first and fourth wavelength ranges appears red to the viewer, illumination light in the second and fifth wavelength ranges appears green to the viewer, and illumination light in the third and sixth wavelength ranges appears blue to the viewer.

In various embodiments, the first illumination arrangement generates electromagnetic radiation having the first polarization, and the second illumination arrangement generates electromagnetic radiation having the second polarization, which differs from the first polarization. By way of example, the first illumination arrangement has a first polarization filter for generating the electromagnetic radiation having the first polarization, and the second illumination arrangement has a second polarization filter for generating the electromagnetic radiation having the second polarization.

In various embodiments, the deflection device includes a first deflection unit for deflecting the first illumination beam and a second deflection unit for deflecting the second illumination beam. As an alternative thereto, both illumination beams can be deflected toward the projection surface with the aid of the same deflection unit. The deflection unit can include for example one or a plurality of mirrors, for example a micromirror array.

In various embodiments, in a wavelength spectrum, in each case one of the wavelength ranges of the first color space is adjacent to one of the wavelength ranges of the second color space, wherein the two adjacent wavelength ranges in each case represent illumination light of the same color. The radiation sources that generate the electromagnetic radiation in the corresponding adjacent wavelength ranges are arranged adjacent to one another. By way of example, the first and fourth radiation sources generate red illumination light, the second and fifth radiation sources generate green illumination light, and the third and sixth radiation sources generate blue illumination light. In that case, for example, the first and fourth radiation sources, the second and fifth radiation sources and the third and sixth radiation sources are respectively arranged alongside one another. By way of example, these pairs of radiation sources are arranged so near to one another that at least partly the same optical system and/or the same optical elements can be used for guiding, polarizing, filtering and/or deflecting the corresponding illumination beams of the same color.

In various embodiments, a plurality of optical elements for deflecting and/or guiding the illumination beams to the deflection device are arranged. The optical elements are designed and arranged such that the illumination beams of two adjacent radiation sources are directed and/or guided to the deflection device via the same optical elements. This can contribute to a precise representation of the first and/or second 3D image and/or to a simple, compact and/or cost-effective design of the projector.

In various embodiments, the projector for projecting the second 3D image onto the projection surface during the projection of the first 3D image on the projection surface includes a third illumination arrangement, which generates the third illumination beam depending on the third image data, which are representative of the first partial image of the second 3D image. The third illumination beam includes electromagnetic radiation having the predefined third property, which differs from the first and second properties. A fourth illumination arrangement generates the fourth illumination beam depending on the fourth image data, which are representative of the second partial image of the second 3D image. The fourth illumination beam includes electromagnetic radiation having the predefined fourth property, which differs from the first, second and third properties. The deflection device deflects the third and fourth illumination beams toward the projection surface such that, with the aid of the third illumination beam, the first partial image of the second 3D image and, with the aid of the fourth illumination beam, the second partial image of the second 3D image are represented on the projection surface.

Embodiments of the invention are illustrated in the figures and are explained in greater detail below.

In the figures:

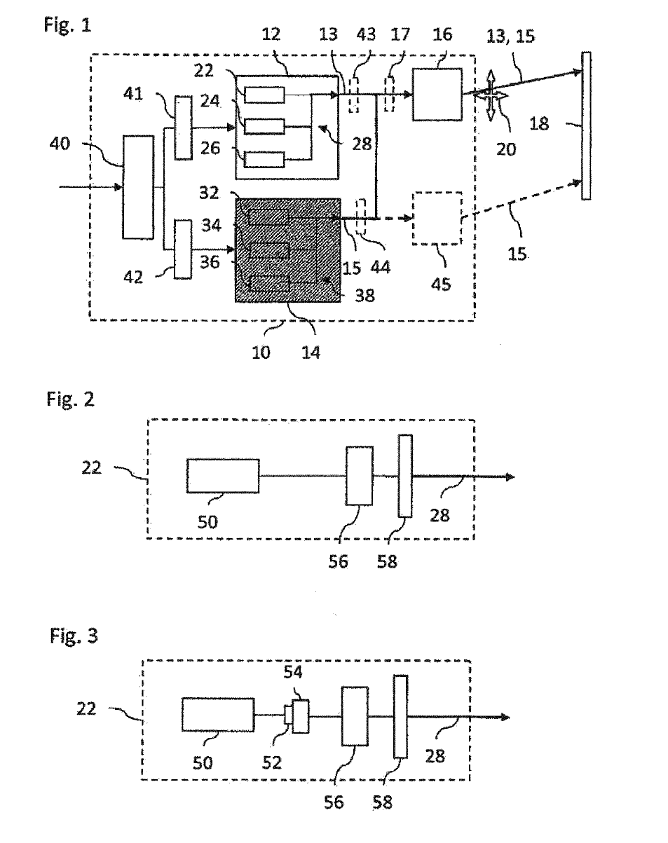

FIG. 1 shows one embodiment of a projector for representing a 3D image;

FIG. 2 shows one embodiment of a radiation source;

FIG. 3 shows a further embodiment of a radiation source;

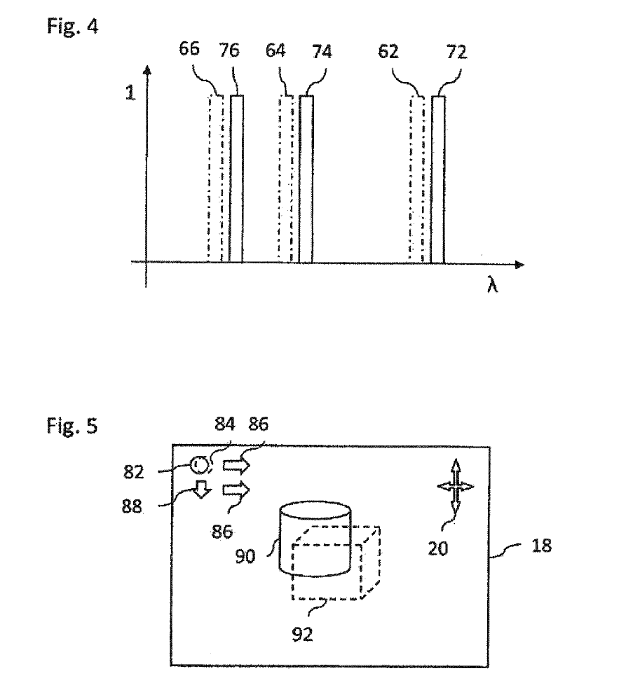

FIG. 4 shows one embodiment of two different color spaces;

FIG. 5 shows one embodiment of a projection surface;

FIG. 6 shows a further embodiment of a projector for representing a 3D image;

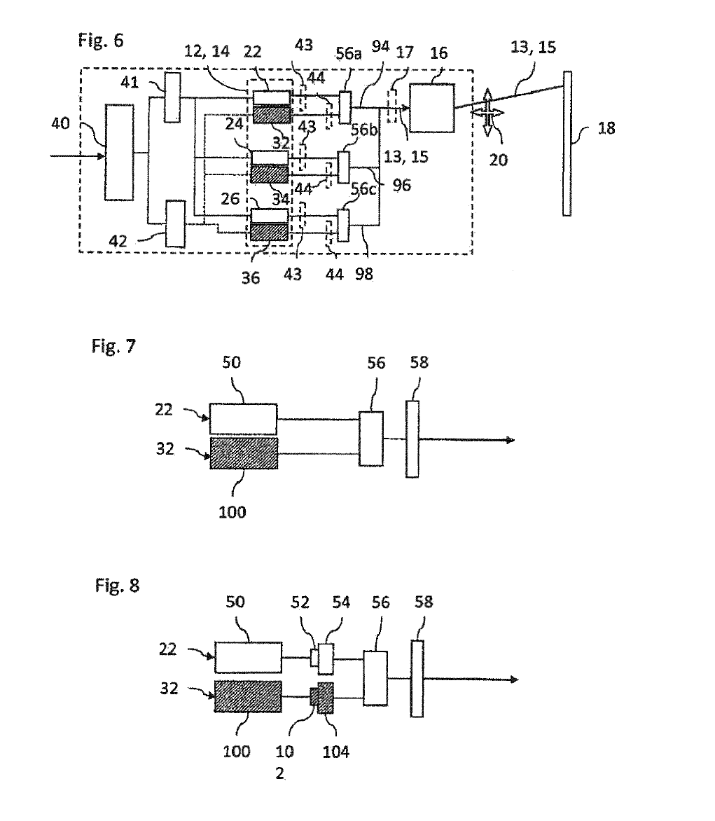

FIG. 7 shows one embodiment of two radiation sources;

FIG. 8 shows a further embodiment of two radiation sources;

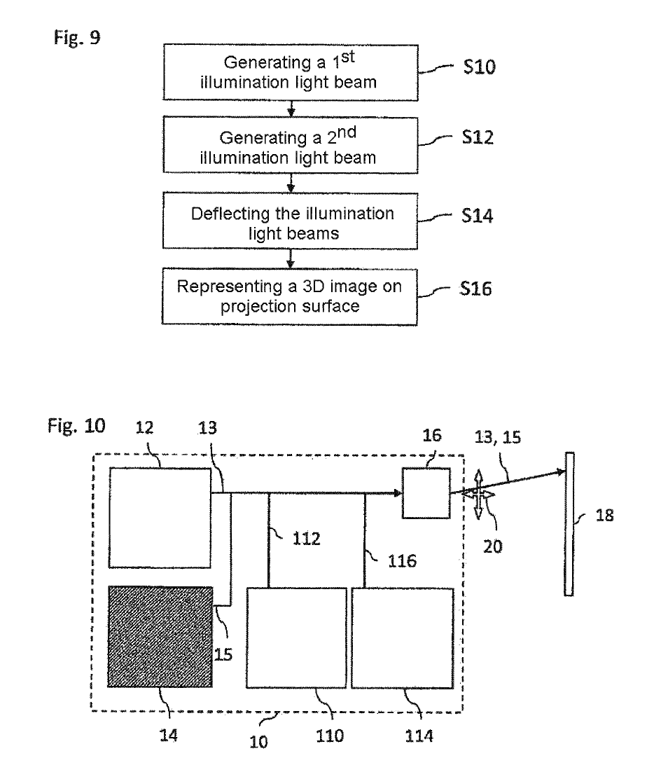

FIG. 9 shows a flow chart of one embodiment of a method for representing a 3D image;

FIG. 10 shows one embodiment of a projector for simultaneously representing two 3D images.

In the following detailed description, reference is made to the accompanying drawings, which form part of this invention and which show, for illustration purposes, specific embodiments in which the invention can be implemented. In this regard, direction terminology such as, for instance, “at the top”, “at the bottom”, “at the front”, “at the back”, “front”, “rear”, etc. is used with reference to the orientation of the figure(s) described. Since components of embodiments can be positioned in a number of different orientations, the direction terminology serves for illustration purposes and is not restrictive in any way at all. It goes without saying that other embodiments can be used and structural or logical amendments can be made, without departing from the scope of protection of the present invention. It goes without saying that the features of the various embodiments described herein can be combined with one another, unless specifically indicated otherwise. Therefore, the following detailed description should not be interpreted in a restrictive sense, and the scope of protection of the present invention is defined by the appended claims.

In the context of this description, the terms “connected” and “coupled” are used to describe both a direct and an indirect connection, and a direct or indirect coupling. In the figures, identical or similar elements are provided with identical reference signs, insofar as is expedient.

FIG. 1 shows a first embodiment of a projector 10 for representing a first 3D image 90 (see FIG. 5) on a projection surface 18. The projector 10 can also be designated as a 3D flying-spot projector. The projector 10 includes a first illumination arrangement 12 and a second illumination arrangement 14. The first illumination arrangement 12 generates a first illumination beam 13 and the second illumination arrangement 14 generates a second illumination beam 15. The first illumination arrangement 12 includes a first radiation source 22, a second radiation source 24 and a third radiation source 26. The first, second and third radiation sources 22, 24, 26 generate a respective first partial beam 28. The first partial beams 28 together form the first illumination beam 13. The second illumination arrangement 14 includes a fourth radiation source 32, a fifth radiation source 34 and a sixth radiation source 36. The fourth, fifth and sixth radiation sources 32, 34, 36 generate a respective second partial beam 38, which together form the second illumination beam 15. The first and second partial beams 28, 38 include electromagnetic radiation. By way of example, the first and second partial beams 28, 38 in each case include illumination light of three primary colors with the aid of which a respective independent color space can be represented. By way of example, the first and second partial beams 28, 38 in each case include red, green and blue illumination light. The illumination arrangements 12, can also be designated as clusters, for example as RGB clusters.

As an alternative thereto, the first illumination arrangement 12 can include only the first and second radiation sources 22, 24, and the second illumination arrangement 14 can include only the fourth and fifth radiation sources 32, 34. The first and second partial beams 28, 38 then include, for example, in each case amber-colored and dark-blue illumination light.

The two illumination beams 13, 15 are deflected toward a deflection device including at least one first deflection unit 16. By way of example, the first deflection unit 16 includes a micromirror arrangement (MEMS) and/or a micromirror actuator. A plurality of optical elements (not illustrated in FIG. 1), such as, for example, lenses, prisms and mirrors, are provided for deflecting and/or guiding the partial beams 28, 38 and/or the illumination beams 13, 15 toward the deflection device. In this case, the beam guiding can be effected, for example, via an angle coupling and/or by beam combining by means of combination prisms, wherein spectrally different light components can be coupled in with combination prisms. The first deflection unit 16 serves to guide the illumination beams 13, over the projection surface 18 such that a first partial image of the first 3D image for a right eye of a first viewer can be represented with the aid of the first illumination beam 13 and a second partial image of the first 3D image for a left eye of the first viewer can be represented with the aid of the second illumination beam 15. For this purpose, the deflection device deflects the illumination beams 13, 15, for example in a manner corresponding to a direction cross 20, upward, downward, rightward and leftward on the projection surface 18. As an alternative or in addition to the first deflection unit 16, the deflection device can include a second deflection unit 45. The second deflection unit 45 can serve, for example, in addition or as an alternative to the first deflection unit 16, to deflect the first and/or the second illumination beam 13, 15 toward the projection surface 18.

Image data representing the first 3D image can be fed into the projector 10 via a video processor 40. By way of example, first image data represent the first partial image for the right eye of the first viewer and second image data represent the second partial image for the left eye of the first viewer. The video processor 40 processes the image data fed in and forwards the processed first image data to a first drive unit 41, which controls the first illumination arrangement 12, and forwards the processed second image data to a second drive unit 42, which controls the second illumination arrangement 14. The illumination arrangements 12, 14 generate the partial beams 28, 38 in a manner dependent on the first and second image data.

A first polarization filter 43 and/or a second polarization filter 44 are/is optionally provided. The first polarization filter 43 serves, for example, to polarize the first illumination beam 13 in accordance with a first polarization, for example to linearly polarize or to circularly polarize said illumination beam. The second polarization filter 44 serves, for example, to polarize the second illumination beam 15 in accordance with a second polarization, for example linearly or circularly, wherein the first polarization differs from the second polarization.

FIG. 2 shows one embodiment of one of the radiation sources 22, 24, 26, 32, 34, 36 of the illumination arrangements 12, 14, for example of the radiation source 22. The radiation source 22 includes a first laser unit 50. The first laser unit 50 includes a laser diode, for example, which generates monochromatic radiation or monochromatic light, for example. By way of example, the first laser unit 50 generates green laser light. The for example green laser or illumination light passes through a collimation lens 56 and subsequently through an optional filter 58, which is a color and/or polarization filter, for example. Alternatively, a different radiation source can also be used. The further radiation sources 24, 26, 32, 34, 36 can be designed for example in accordance with the first radiation source 22. The filter 58 can be provided in addition or as an alternative to the first polarization filter 43 and/or the second polarization filter 44.

FIG. 3 shows an alternative embodiment of one of the radiation sources 22, 24, 26, 32, 34, 36 of the illumination arrangements 12, 14, for example of the radiation source 22. The radiation source 22 includes the first laser unit 50. In this embodiment, the first laser unit 50 serves, for example, as a pump radiation source and is directed at a first conversion element 52. The first laser unit 50 can emit pulsed or continuous laser light. The first laser unit 50 includes a laser diode, for example. The first conversion element 52 is held by a transparent carrier 54. The first conversion element includes phosphors and/or a phosphor mixture which can be excited to emit light with the aid of the laser light of the first laser unit 50, wherein the first conversion element 52 converts the laser light, which can be designated as excitation radiation in this context, into conversion radiation.

During the conversion, the wavelengths of the excitation radiation are converted. By way of example, during an up-conversion, the wavelengths of the excitation radiation are converted into shorter wavelengths, the conversion radiation then having the shorter wavelengths. In other words, during the up-conversion, a wavelength range of the excitation radiation is shifted toward shorter wavelengths. As an alternative thereto, during a down-conversion, the wavelengths of the excitation radiation are converted into longer wavelengths, the conversion radiation then having the longer wavelengths. In other words, during the down-conversion, a wavelength range of the excitation radiation is shifted toward longer wavelengths.

The phosphors include fluorescent and/or phosphorescent substances, for example. The phosphors include for example calsin (CaAlSiN3:Eu) for example for the purpose of generating red light, for example green-emitting phosphor, for example cerium-doped YAG (Ba0.40Eu0.60Mn0.30)MgA110017, for the purpose of generating green light and/or for example YAG:Ce (Y0.96Ce0.04)3 Al3.75 Ga1.25 O12 for the purpose of generating yellow light. By way of example, the first laser unit 50 generates blue laser light which excites green-phosphorescent phosphors to emit light in the conversion element 52. In this context, the blue laser light can also be designated as excitation radiation. The converted laser light and the for example green illumination light generated as a result passes through the first carrier 54 and subsequently through the collimation lens 56 and the optional filter 58, which is a color and/or polarization filter, for example. In this context, the first radiation source 22 can be designated as an LARP (Laser Activated Remote Phosphor) radiation source. Alternatively, a different radiation source can also be used. The further radiation sources 24, 26, 32, 34, 36 can be designed for example in accordance with the first radiation source 22.

FIG. 4 shows a wavelength diagram depicting two different color spaces. A first color space has a first wavelength range 62, a second wavelength range 64 and a third wavelength range 66. A second color space, which differs from the first color space, has a fourth wavelength range 72, a fifth wavelength range 74 and a sixth wavelength range 76. Illumination light of the wavelengths from the first and fourth wavelength ranges 62, 72 is perceived as red light, for example, by a viewer. Illumination light of the wavelengths from the second and fifth wavelength ranges 64, 74 is perceived as green light, for example, by a viewer. Illumination light of the wavelengths from the third and sixth wavelength ranges 66, 76 is perceived as blue light, for example, by a viewer. Each of the two color spaces can be designated by itself as an RGB color space. Generally, the color spaces can also be designated as wavelength spaces. By way of example, both color spaces are chosen such that the same white point can be represented by them in a projection.

By way of example, the first wavelength range 62 has wavelengths of between 635 and 645 nm. By way of example, the second wavelength range 64 has wavelengths of between 510 and 520 nm. By way of example, the third wavelength range 66 has wavelengths of between 440 and 450 nm. By way of example, the fourth wavelength range 72 has wavelengths of between 650 and 660 nm. By way of example, the fifth wavelength range 74 has wavelengths of between 525 nm and 535 nm. By way of example, the sixth wavelength range 76 has wavelengths of between 455 and 465 nm. Each of the wavelength ranges has a centroid wavelength lying approximately in the center of the corresponding wavelength range, for example. Two different wavelength ranges of the same color have a predefined spacing relative to one another, for example. The predefined spacing can be chosen for example depending on a selectivity of filter spectacles to be used. If the filter spectacles have a selectivity of 5 nm, for example, then the predefined spacing is greater than or equal to 5 nm, for example. A plurality of wavelengths can occur within each of the wavelength ranges (longitudinal modes).

By way of example, the first radiation source 22 generates electromagnetic radiation having wavelengths from the first wavelength range 62, the second radiation source 24 generates electromagnetic radiation having wavelengths from the second wavelength range 64, the third radiation source 26 generates electromagnetic radiation having wavelengths from the third wavelength range 66, the fourth radiation source 32 generates electromagnetic radiation having wavelengths from the fourth wavelength range 72, the fifth radiation source 34 generates electromagnetic radiation having wavelengths from the fifth wavelength range 74, and the sixth radiation source 36 generates electromagnetic radiation having wavelengths from the sixth wavelength range 76. Consequently, the radiation sources 22, 24, 26 of the first illumination arrangement 12 generate electromagnetic radiation having wavelengths from the first color space, and the radiation sources 32, 34, 36 of the second illumination arrangement 14 generate electromagnetic radiation having wavelengths from the second color space. In other words, first illumination light of the first illumination arrangement 12 spans the first color space, and second illumination light of the second illumination arrangement 14 spans the second color space.

As an alternative thereto, one of the color spaces can respectively be spanned by illumination light from only two wavelength ranges, for example if each illumination arrangement 12, 14 includes only two radiation sources or two radiation sources of an illumination arrangement 12, 14 emit electromagnetic radiation in the same wavelength range.

FIG. 5 shows a plan view of the projection surface 18. The first partial images of the first 3D image 90 for the right eye of the first viewer can be represented on the projection surface 18 with the aid of the first electromagnetic radiation, and the second partial images of the first 3D image for the left eye of the first viewer can be represented on the projection surface 18 with the aid of the second electromagnetic radiation. Preferably, the radiation sources generate electromagnetic radiation in the corresponding wavelength ranges under all conditions that typically occur, for example at temperatures of between ten and seventy degrees Celsius. If necessary, the radiation sources can be readjusted depending on the ambient temperature in order thus to generate a substantially constant emission wavelength.

Optionally, the electromagnetic radiation of the first color space can be polarized differently than the electromagnetic radiation of the second color space. By way of example, the electromagnetic radiation in the first, second and third wavelength ranges 62, 64, 66 has a first polarization, which is right-circular, for example, and the electromagnetic radiation in the fourth, fifth and sixth wavelength ranges 72, 74, 76 has a second polarization, which is left-circular, for example.

The separation of the two partial images of the 3D image for the right and left eyes of the viewer takes place on the part of the first viewer with the aid of first filter spectacles. The first filter spectacles have a different filter for the right eye of the first viewer than for the left eye of the first viewer. Depending on the type of representation of the partial images, the first filter spectacles can have color and/or polarization filters. By way of example, a right spectacle lens of the first filter spectacles transmits illumination light of the first color space and/or having the first polarization and filters out illumination light of the second color space and/or having the second polarization, and a left spectacle lens of the filter spectacles transmits illumination light of the second color space and/or having the second polarization and filters out illumination light of the first color space and/or having the first polarization. It goes without saying that these explanations hold true independently of whether the illumination light of the first color space is incident on the left eye of the first viewer and the illumination light of the second color space is incident on the right eye of the first viewer, or vice versa.

The projector 10 and the first filter spectacles together form a projection system for representing a 3D image on a projection surface.

The color space of the electromagnetic radiation and/or the polarization of the electromagnetic radiation are properties of the electromagnetic radiation. By way of example, the first color space and/or the first polarization are/is a first property of the electromagnetic radiation, and the second color space and/or the second polarization are/is a second property of the electromagnetic radiation.

The first illumination beam 13 generates a first beam spot 82 and the second illumination beam 15 generates a second beam spot 84. The two beam spots 82, 84 are illustrated alongside one another for clarification purposes in FIG. 5, but during the operation of the projector 10 they can occasionally or permanently lie one above another, for example congruently and/or in a manner being superimposed on one another. During normal operation of the projector 10, the two beam spots 82, 84 are moved over the projection surface 18 so rapidly that, to the first viewer, they are no longer discernible as individual beam spots 82, 84, but rather as partial images and together as a 3D image or 3D film. By way of example, the two beam spots 82, 84 are moved over the projection surface 18 along a first direction 86 and along a second direction 88, which is perpendicular to the first direction 86. In other words, the projection surface 18 is scanned for example line by line by the beam spots 82, 84.

The color with which the two beam spots 82, 84 appear on the projection surface 18 can be set by the control of the mixing of the partial beams 28, 38. By way of example, the color of the first beam spot 82 can be set by a mixing of the first partial beams 28, and a color of the second beam spot 84 can be set by a mixing of the second partial beams 38. If the first beam spot 82 is intended to appear exclusively red, for example, then for example the second and third radiation sources 24, 26 can be switched off or the corresponding first partial beams 28 can be shaded. If, in contrast thereto, the first beam spot 82 is intended to appear white, for example, then this can be achieved for example by a uniform mixing of the first partial beams 28 of the first, second and third radiation sources 22, 24, 26. The color setting of the second beam spot 84 is correspondingly effected via the driving of the second illumination arrangement 14. The first partial image generated with the aid of the first beam spot 82 for the right eye of the first viewer and the second partial image generated with the aid of the second beam spot 84 for the left eye of the first viewer together form the first (stereoscopic) 3D image 90, which makes a spatial (three-dimensional) impression on the first viewer. The separation of the partial images of the first 3D image on the part of the first viewer is effected via the first filter spectacles. The first filter spectacles have an optical filter for the right eye of the first viewer, said optical filter transmitting electromagnetic radiation of the first color space and filtering out electromagnetic radiation of the second color space, and have an optical filter for the left eye of the first viewer, said optical filter transmitting electromagnetic radiation of the second color space and filtering out electromagnetic radiation of the first color space.

As an alternative or in addition to the separation of the partial images for the right eye and the left eye of the first viewer with the aid of different color spaces, the separation of the partial images can also be obtained with differently polarized illumination beams 13, 15. By way of example, the first illumination beam 13 can be polarized in accordance with the first polarization with the aid of the first polarization filter 43, and the second illumination beam 15 can be polarized in accordance with the second polarization with the aid of the second polarization filter 44. By way of example, the two illumination beams 13, 15 can be linearly polarized, the polarization of the first illumination beam 13 being perpendicular to the polarization of the second illumination beam 15, for example. As an alternative thereto, the illumination beams 13, 15 can be circularly polarized. By way of example, the first illumination beam 13 can be left-circularly polarized with the aid of the first polarization filter 43, and the second illumination beam 15 can be right-circularly polarized with the aid of the second polarization filter 44. The first beam spot 82 then includes illumination light that is differently polarized than the illumination light of the second beam spot 84. With the aid of the two beam spots 82, 84, the partial images of the first 3D image 90 can then be generated as described above. The separation of the partial images of the first 3D image on the part of the first viewer then takes place via the first filter spectacles, which have an optical filter for the right eye of the first viewer, said optical filter transmitting electromagnetic radiation having the first polarization and filtering out electromagnetic radiation having the second polarization, and have an optical filter for the left eye of the first viewer, said optical filter transmitting electromagnetic radiation having the second polarization and filtering out electromagnetic radiation having the first polarization. The polarization filters 43, 44 can also be integrated in the corresponding illumination arrangements 12, 14.

In the case of differently polarized electromagnetic radiation, the same color space can be used for both beam spots 82, 84 or two different color spaces can be used. By way of example, the separation of the two partial images can be obtained, in principle, by means of different color spaces, wherein a selectivity of the partial images can additionally be obtained with the aid of different polarization of the illumination light of the corresponding partial images. The separation of the partial images of the first 3D image on the part of the first viewer then takes place by means of the first filter spectacles, which have an optical filter for the right eye of the first viewer, said optical filter transmitting electromagnetic radiation of the first color space and having the first polarization and filtering out electromagnetic radiation of the second color space and having the second polarization, and have an optical filter for the left eye of the first viewer, said optical filter transmitting electromagnetic radiation of the second color space and having the second polarization and filtering out electromagnetic radiation of the first color space and having the first polarization.

If the separation of the partial images takes place by means of the polarization, then the projection surface 18 should be designed in a polarization-maintaining fashion. By way of example, the projection surface 18 can have a metal coating, for example a silver layer. If the separation of the partial images takes place exclusively by means of the different color spaces, then a simple, for example white, projection screen or wall can serve as the projection surface 18.

In addition to the first illumination arrangement 12 and the second illumination arrangement 14, two or more further illumination arrangements 110, 114 (see FIG. 10) can also be provided, with the aid of which, for example, on the projection surface 18, a second 3D image 92 for a second viewer can be represented during the representation of the first 3D image 90 for the first viewer, which is explained in greater detail further below with reference to FIG. 10. The second 3D image can then represent a different image content and/or a different image than the first 3D image.

FIG. 6 shows a further embodiment of the projector 10. The elements of the projector 10 of this embodiment largely correspond to the elements of the embodiment of the projector 10 as shown in FIG. 1. The essential difference between the two embodiments is that the two illumination arrangements 12, 14 are not spatially separated in the embodiment shown in FIG. 6. The radiation sources 22, 24, 26, 32, 34, 36 of the illumination arrangements 12, 14 are arranged in pairs in this embodiment. By way of example, two of the radiation sources 22, 24, 26, 32, 34, 36 which generate illumination light of the same color are always arranged adjacent, for example directly alongside one another. By way of example, the first and fourth radiation sources 22, 32, the second and fifth radiation sources 24, 34, and the third and sixth radiation sources 26, 36 are arranged directly alongside one another.

The first, second and third radiation sources 22, 24, 26 are optionally assigned a respective first polarization filter 43, the functioning of which corresponds to that of the first polarization filter 43 explained above, and the fourth, fifth and sixth radiation sources 32, 34, 36 are optionally assigned a respective second polarization filter 44, the functioning of which corresponds to that of the second polarization filter 44 explained above. Consequently, the first polarization filters 43 are suitable for polarizing the electromagnetic radiation of the first, second and third radiation sources 22, 24, 26, for example in accordance with the first polarization, and the second polarization filters 44 are suitable for polarizing the electromagnetic radiation of the fourth, fifth and sixth radiation sources 32, 34, 36, for example in accordance with the second polarization.

The first and fourth radiation sources 22, 32 are assigned a first collimation lens 56a. The second and fifth radiation sources 24, 34 are assigned a second collimation lens 56b. The third and sixth radiation sources 26, 36 are assigned a third collimation lens 56c. The partial beams of the first and fourth radiation sources 22, 32 are focused with the aid of the first collimation lens 56a to form a red partial beam 94, for example. The partial beams of the second and fifth radiation sources 24, 34 are focused with the aid of the second collimation lens 56b to form a green partial beam 96, for example. The partial beams of the third and sixth radiation sources 26, 36 are focused with the aid of the third collimation lens 56c to form a blue partial beam 98, for example. The red, green and respectively blue partial beams 94, 96, 98 are then deflected toward the deflection device 16.

FIG. 7 shows one embodiment of two adjacent radiation sources, for example of the first radiation source 22 and the fourth radiation source 32, of the projector 10 in accordance with FIG. 6. In this embodiment, the fourth radiation source 32 has a second laser unit 100 and a second carrier 104. The first and fourth radiation sources 22 and 32 and/or the first and second laser units 50, 100 can also be designated as a package in this context and/or be arranged on a common substrate. The further radiation sources 24, 26, 34, 36 can be designed for example in accordance with the first radiation source 22 and the fourth radiation source 32.

The arrangement, design and/or function of the second laser unit 100 can substantially correspond to the arrangement, design and/or function of the first laser unit 50, wherein the wavelengths of the electromagnetic radiation generated by the second laser unit 100 are shifted at least slightly relative to the wavelengths of the electromagnetic radiation generated by the first laser unit 50. By way of example, electromagnetic radiation in the first wavelength range 62 is generated by the first laser unit, and electromagnetic radiation in the fourth wavelength range 72 is generated by the second laser unit 100.

As a result of the adjacent arrangement of the two radiation sources 22, 32 or of the two laser units 50, 100, the collimation lens 56 and the polarization filter 58 and also deflection or diversion elements (not illustrated), such as dichroic mirrors, for example, can be used jointly for the illumination light of the same color. The adjacent laser units 50, 100 can be arranged on a substrate. The emission points of the laser units 50, 100 can be spaced apart from one another for example by less than 100 μm, less than 50 μm or less than 10 μm. A field of view (FOV) of the downstream optical system can then be adapted to this spacing. In the beam direction, a spacing of the laser units 50, 100 relative to one another, for example on account of a production tolerance, can be less than 5 μm, less than 2 μm or less than 1 μm. The beam spots 82, 84 can have identical or similar sizes on the projection surface if the laser units 50, 100 have identical or similar divergence angles, for example. By way of example, the divergence can be less than 5 degrees, for example less than 2 degrees or less than 1 degree, applicable in each case to both axes.

FIG. 8 shows an alternative embodiment of two adjacent radiation sources, for example of the first radiation source 22 and the fourth radiation source 32, of the projector 10 in accordance with FIG. 6. In this embodiment, the fourth radiation source 32 has the second laser unit 100, a second conversion element 102 and a second carrier 104. The first and fourth radiation sources 22, 32 and/or the first and second laser units 50, 100 can also be designated as a package in this context and/or be arranged on a common substrate. The first and/or the second radiation source 22, 32 can be designated as LARP (Laser Activated Remote Phosphor) radiation sources in this embodiment. Alternatively, other radiation sources can also be used. The further radiation sources 24, 26, 34, 36 can be designed for example in accordance with the first radiation source 22 and the fourth radiation source 32.

The arrangement, design and/or function of the second laser unit 100, of the second conversion element 102 and of the second carrier 104 can substantially correspond to the arrangement, design and/or function of the first laser unit 50, of the first conversion element 52 and of the first carrier 54, respectively, wherein the wavelengths of the illumination light generated in the second conversion element 102 are shifted at least slightly relative to the wavelengths of the illumination light generated in the first conversion element 52. By way of example, illumination light in the first wavelength range 62 is generated in the first conversion element 52, and illumination light in the fourth wavelength range 72 is generated in the second conversion element 102.

As an alternative to the second laser unit 100, the second conversion element 102 can also be assigned to the first laser unit 50, such that the first laser unit 50 excites the phosphors in the second conversion element 102 to emit light, and the second laser unit 100 can be dispensed with. Consequently, for exciting the phosphors in the first conversion element 52 it is possible to use the same laser radiation source as for exciting the phosphors in the second conversion element 102. By way of example, the phosphors of both conversion elements 52, 102 can be excited to emit light with the aid of blue laser light, for example from the first laser unit 50. In this case, the phosphors of the conversion elements 52, 102 are chosen such that after the excitation thereof, they emit the illumination light from the corresponding wavelength range upon de-excitation. By way of example, the first conversion element 52 can emit red illumination light in the first wavelength range 62, and the second conversion element 102 can emit red illumination light in the fourth wavelength range 72.

Furthermore, as a result of the adjacent arrangement of the two radiation sources 22, 32 or of the two laser units 50, 100, the collimation lens 56 and the polarization filter 58 and also deflection or diversion elements (not illustrated), such as dichroic mirrors, for example, can be used jointly for the illumination light of the same color. The adjacent laser units 50, 100 and/or the adjacent conversion elements 52, 102 can be arranged on a substrate. The emission points of the laser units 50, 100 and/or of the conversion elements 52, 102 can be spaced apart from one another for example by less than 100 μm, less than 50 μm or less than 10 μm. A field of view (FOV) of the downstream optical system can then be adapted to this spacing. In the beam direction, a spacing of the laser units 50, 100 relative to one another, for example on account of a production tolerance, can be less than 5 μm, less than 2 μm or less than 1 μm. The beam spots 82, 84 can have identical or similar sizes on the projection surface 18 if the laser units 50, 100 have identical or similar divergence angles, for example. By way of example, the divergence can be less than 5 degrees, for example less than 2 degrees or less than 1 degree, applicable in each case to both axes.

FIG. 9 shows a flow chart of one embodiment of a method for representing a 3D image, for example the first 3D image 90, on the projection surface 18.

A step S10 involves generating a first illumination beam, for example the first illumination beam 13. The first illumination beam 13 is generated depending on the first image data, which are representative of the first partial image of the first 3D image 90 for the right eye of the viewer. In particular, a current color mixing of the first illumination beam 13 depends on the first image data. In this context, the color mixing is achieved for example by a mixing of the first partial beams 28. Different mixings can be generated for example by different intensities of the individual first partial beams 28.

A step S12 involves generating a second illumination beam, for example the second illumination beam 15. The second illumination beam 15 is generated depending on the second image data, which are representative of the second partial image of the first 3D image 90 for the left eye of the viewer. In particular, a current color mixing of the second illumination beam 15 depends on the second image data. In this context, the color mixing is achieved for example by a mixing of the second partial beams 38. Different mixings can be generated for example by different intensities of the individual second partial beams 28.

A step S14 involves directing the two illumination beams 13, 15 toward the projection surface 18, to be precise such that the corresponding partial images are represented on the projection surface 18. By way of example, the first illumination beam 13 and the second illumination beam 15 are directed simultaneously onto the projection surface 18, such that the two partial images of the first 3D image 90 are simultaneously represented on the projection surface 18.

With the aid of the partial images represented, the first 3D image 90 is represented on the projection surface 18 in a step S16. In addition, the second 3D image 92 for the second viewer or even further 3D images, for example a 3D slide show, a 3D film and/or a 3D computer game, can also be represented on the projection surface 18.

FIG. 10 shows a further embodiment of the projector 10. The elements of this embodiment largely correspond to the elements of the embodiment of the projector 10 as shown in FIG. 1. The essential difference between the two embodiments is that the projector 10 in accordance with FIG. 10 includes a third illumination arrangement 110 and a fourth illumination arrangement 114. The projector 10 in accordance with FIG. 10 can also be designated as a projector 10 for simultaneously representing two 3D images on a projection surface 18. By way of example, with the projector 10 in accordance with FIG. 10, the first and second 3D images can be represented on the projection surface 18 simultaneously or quasi-simultaneously in a manner being superimposed on one another.

The third illumination arrangement 110 generates a third illumination beam 112 and the fourth illumination arrangement 114 generates a fourth illumination beam 116. The third illumination arrangement 110 is designed for example such that the third illumination beam 112 includes electromagnetic radiation having wavelengths of a third color space. The fourth illumination arrangement 114 is designed for example such that the fourth illumination beam 116 includes electromagnetic radiation having wavelengths of a fourth color space. The third color space has electromagnetic radiation from different wavelength ranges than the first, second or fourth color space. The fourth color space has electromagnetic radiation from different wavelength ranges than the first, second or third color space. By way of example, the centroid wavelength in the green color range is around 505 nm in the case of the first color space, around 515 nm in the case of the second color space, around 525 nm in the case of the third color space and around 535 nm in the case of the fourth color space. The separation of the color spaces and of the partial images of the second 3D image for the second viewer then takes place by means of correspondingly designed second filter spectacles. The third color space is a third property of the electromagnetic radiation, and the fourth color space is a fourth property of the electromagnetic radiation.

Given a sufficient selectivity of the filter spectacles, yet another color space could be generated with the aid of further illumination arrangements and a further 3D image could thus be generated simultaneously with the first and second 3D images 90, 92 on the projection surface 18. Alternatively or additionally, the selectivity can be increased by combining the different color spaces with the different polarization of the electromagnetic radiation.

The third and fourth color spaces differ from one another and from the first and second color spaces. In other words, the third illumination beam 112 spans the third color space and the fourth illumination beam 116 spans the fourth color space. With the aid of the third illumination beam 112, a first partial image for the second 3D image 92 for a right eye of the second viewer is represented on the projection surface 18 and, with the aid of the fourth illumination beam 116, a second partial image for the second 3D image 92 for a left eye of the second viewer is represented on the projection surface 18. In this way, by way of example, two different viewers can simultaneously see different 3D images, 3D films and/or 3D computer animations on the same projection surface 18. By way of example, two viewers can simultaneously see the same computer game, for example from different perspectives, on the same projection surface 18.

As an alternative or in addition to the separation of the partial images of the second 3D image by means of different color spaces, the separation can also be obtained by means of different polarizations of the third illumination beam 13 and of the fourth illumination beam 15, in a manner corresponding to the above-explained separation of the partial images of the first 3D image 90 by means of polarization of the first illumination beam 13 and of the second illumination beam 15.

A separation of the partial images on the part of the second viewer then takes place by means of the second filter spectacles, which, for the right eye of the second viewer, transmit electromagnetic radiation having the third property and filter out electromagnetic radiation having the first, second and fourth properties and which, for the left eye of the second viewer, transmit illumination light having the fourth property and filter out electromagnetic radiation having the first, second and third properties.

The projector 10 according to one of the embodiments explained above can generate for example white illumination light with 30 1 m, for example if all six radiation sources are active. This can require a high wavelength in the red color range, for example, for which reason a high C6 factor is required with regard to eye safety (see IEC 60825-13 Ed. 2). This can be achieved, for example, by a mirror of the deflection device having a suitable size or being operated in combination with a suitable lens.

The invention is not restricted to the embodiments specified. By way of example, the polarization filters 43, 44 can be integrated in the illumination arrangements 13, 15. Moreover, the projection device according to the invention can include more than two illumination arrangements, for example three or four, such that more than two 3D images or 3D films can be simultaneously projected onto the projection surface, for example three or four. Furthermore, the concept of the separation of the partial images by using different color spaces can also be applied to the non-visible ranges of the light or electromagnetic radiation; by way of example, electromagnetic radiation whose wavelength ranges are in the UV light range and/or in the infrared light range can be used for representing the partial images. The use of the term “color space” then relates only to the aggregation of different wavelength ranges and thus to a so-called wavelength space, and no longer to colors actually perceptible to humans without aids. Consequently, in this application, the term “light” is synonymous with the term “radiation” and the term “color” is synonymous with radiation in a wavelength range which gives a viewer a specific color or gray impression—with or without aids, such as e.g. filter spectacles. The partial images are then discernible to the viewer or viewers with the aid of filter spectacles which have a residual light amplification in the case of infrared radiation and have a corresponding optical filter in the case of UV radiation. This enables a projection of image data in such a way that the latter are discernible exclusively with the aid of the filter spectacles and are invisible to any person without corresponding filter or amplifier spectacles.

The projection device according to the invention can be used for example in video and data projection, for the projection of 3D computer games for which a plurality of players respectively see the 3D sequences assigned to them on the same projection surface and/or for which the game participants can interactively choose or influence the outcome of their game or film independently of the other players. The projection device according to the invention can be used for technical, medical and informative augmented reality projection and in rear-projection television sets.

### LIST OF REFERENCE SIGNS

10 Projector
12 First illumination arrangement
13 First illumination beam
14 Second illumination arrangement
15 Second illumination beam
16 First deflection unit
17 Modulator
18 Projection surface
20 Direction cross
22 First radiation source
24 Second radiation source
26 Third radiation source
28 First partial beams
32 Fourth radiation source
34 Fifth radiation source
36 Sixth radiation source
38 Second partial beams
40 Video processor
41 First drive unit
42 Second drive unit
43 First polarization filter
44 Second polarization filter
45 Second deflection unit
50 First laser unit
52 First conversion element
54 First carrier
56 Collimation lens
56a First collimation lens
56b Second collimation lens
56c Third collimation lens
58 Filter
62 First wavelength range
64 Second wavelength range
66 Third wavelength range
72 Fourth wavelength range
74 Fifth wavelength range
76 Sixth wavelength range
82 First beam spot
84 Second beam spot
86 First direction
88 Second direction
90 First 3D image
92 Second 3D image
94 Red partial beam
96 Green partial beam
98 Blue partial beam
100 Second laser unit
102 Second conversion element
104 Second carrier
S10-S16 Steps 10 to 16

1. A method for projecting a first 3D image (90) onto a projection surface (18), wherein the first 3D image (90) comprises a first partial image for a right eye of a first viewer of the first 3D image (90) and a second partial image for a left eye of the first viewer of the first 3D image (90), wherein
a first illumination beam (13) is generated depending on first image data, which are representative of the first partial image of the first 3D image (90), wherein the first illumination beam (13) comprises electromagnetic radiation having a predefined first property;
a second illumination beam (15) is generated depending on second image data, which are representative of the second partial image of the first 3D image (90), wherein the second illumination beam (15) comprises electromagnetic radiation having a predefined second property, which differs from the first property;
the first and second illumination beams (15) are deflected toward the projection surface (18) such that the first illumination beam (13) generates a first beam spot (82) on the projection surface (18) and the second illumination beam (15) generates a second beam spot (84) on the projection surface (18), wherein the first beam spot (82) is moved over the projection surface (18) such that the first partial image of the first 3D image (90) is represented with the aid of the first beam spot (82), and the second beam spot (84) is moved over the projection surface (18) such that the second partial image of the first 3D image (90) is represented on the projection surface (18) with the aid of the second beam spot (84).

2. The method as claimed in claim 1, wherein colored illumination light of a first color space is used as electromagnetic radiation having the predefined first property, and wherein colored illumination light of a second color space is used as electromagnetic radiation having the predefined second property.

3. The method as claimed in claim 2, wherein the first and second color spaces are chosen such that the same white point can be represented with both color spaces.

4. The method as claimed in any of the preceding claims, wherein electromagnetic radiation having a first polarization is used as electromagnetic radiation having the predefined first property, and wherein electromagnetic radiation having a second polarization is used as electromagnetic radiation having the predefined second property.

5. The method as claimed in any of the preceding claims, wherein the two beam spots (82, 84) are projected onto the projection surface (18) in a manner being superimposed on one another.

6. The method as claimed in any of the preceding claims, wherein
during the representation of the first 3D image (90) a second 3D image (92) is represented on the projection surface (18), wherein the second 3D image (92) comprises a first partial image for a right eye of a second viewer of the second 3D image (92) and a second partial image for a left eye of the second viewer of the second 3D image (92), wherein
a third illumination beam (112) is generated depending on third image data, which are representative of the first partial image of the second 3D image (92), wherein the third illumination beam (112) comprises electromagnetic radiation having a predefined third property, which differs from the first and second properties;
a fourth illumination beam (116) is generated depending on fourth image data, which are representative of the second partial image of the second 3D image (92), wherein the fourth illumination beam (116) comprises electromagnetic radiation having a predefined fourth property, which differs from the first, second and third properties;
the third and fourth illumination beams (112, 116) are deflected toward the projection surface (18) such that the third illumination beam (112) generates a third beam spot on the projection surface (18) and the fourth illumination beam (116) generates a fourth beam spot (84) on the projection surface (18), wherein the third beam spot is moved over the projection surface (18) such that the first partial image of the second 3D image (92) is represented with the aid of the third beam spot, and the fourth beam spot is moved over the projection surface (18) such that the second partial image of the second 3D image (92) is represented on the projection surface (18) with the aid of the fourth beam spot.

7. A projector (10) for projecting a first 3D image (90) onto a projection surface (18), wherein the first 3D image (90) comprises a first partial image for a right eye of a first viewer of the first 3D image (90) and a second partial image for a left eye of the first viewer of the first 3D image (90), the projector (10) comprising:
a first illumination arrangement (12), which generates a first illumination beam (13) depending on first image data, which are representative of the first partial image of the first 3D image (90), wherein the first illumination beam (13) comprises electromagnetic radiation having a predefined first property;
a second illumination arrangement (14), which generates a second illumination beam (15) depending on second image data, which are representative of the second partial image of the first 3D image (90), wherein the second illumination beam (15) comprises electromagnetic radiation having a predefined second property, which differs from the first property;
a deflection device (16, 45) designed such that it deflects the first and second illumination beams (13, 15) toward the projection surface (18) such that the first illumination beam (13) generates a first beam spot (82) on the projection surface (18) and the second illumination beam (15) generates a second beam spot (84) on the projection surface (18), wherein the first beam spot (82) is moved over the projection surface (18) such that the first partial image of the first 3D image (90) is represented with the aid of the first beam spot (82), and the second beam spot (84) is moved over the projection surface (18) such that the second partial image of the first 3D image (90) is represented on the projection surface (18) with the aid of the second beam spot (84).

8. The projector (10) as claimed in claim 7, wherein the first illumination arrangement (12) is designed such that it generates electromagnetic radiation of a first color space, and wherein the second illumination arrangement (14) is designed such that it generates electromagnetic radiation of a second color space, which differs from the first color space.

9. The projector (10) as claimed in claim 8, wherein the first illumination arrangement (12) comprises:
a first radiation source (22), which is designed such that it generates electromagnetic radiation in a first wavelength range (62),
a second radiation source (24), which is designed such that it generates electromagnetic radiation in a second wavelength range (64),
a third radiation source (26), which is designed such that it generates electromagnetic radiation in a third wavelength range (66), wherein the electromagnetic radiation in the first, second and third wavelength ranges (62, 64, 66) spans the first color space; and wherein the second illumination arrangement (14) comprises:
a fourth radiation source (32), which is designed such that it generates electromagnetic radiation in a fourth wavelength range (72),
a fifth radiation source (34), which is designed such that it generates electromagnetic radiation in a fifth wavelength range (74),
a sixth radiation source (36), which is designed such that it generates electromagnetic radiation in a sixth wavelength range (76), wherein the electromagnetic radiation in the fourth, fifth and sixth wavelength ranges (72, 74, 76) spans the second color space.

10. The projector (10) as claimed in any of claims 7 to 9, wherein the first illumination arrangement (12) generates electromagnetic radiation having a first polarization, and wherein the second illumination arrangement (14) generates electromagnetic radiation having a second polarization, which differs from the first polarization.

11. The projector (10) as claimed in claim 10, wherein the first illumination arrangement (12) comprises a first polarization filter (43) for generating the electromagnetic radiation having the first polarization, and wherein the second illumination arrangement (14) comprises a second polarization filter (44) for generating the electromagnetic radiation having the second polarization.

12. The projector (10) as claimed in any of claims 7 to 11, wherein the deflection device (16, 45) comprises a first deflection unit (16) for deflecting the first illumination beam (13) and a second deflection unit (45) for deflecting the second illumination beam (15).

13. The projector (10) as claimed in any of claims 7 to 12, wherein in each case one of the wavelength ranges (62, 64, 66) of the first color space in a wavelength spectrum is adjacent to one of the wavelength ranges (72, 74, 76) of the second color space, wherein the electromagnetic radiation in the two adjacent wavelength ranges (62 and 72, 64 and 74, 66 and 76) has the same color, and wherein the radiation sources (22 and 32, 24 and 34, 26 and 36) which generate the electromagnetic radiation in the corresponding wavelength ranges (62 and 72, 64 and 74, 66 and 76) are arranged adjacent to one another.

14. The projector (10) as claimed in claim 13, comprising a plurality of optical elements for deflecting and/or guiding the illumination beams (13, 15) to the deflection device (16, 45), wherein the optical elements are designed and arranged such that the illumination beams (13, 15) of two adjacent radiation sources (62 and 72, 64 and 74, 66 and 76) are directed and/or guided to the deflection device (16, 45) via the same optical elements.

15. The projector (10) as claimed in any of claims 7 to 14, for projecting a second 3D image (92) onto the projection surface (18) during the projection of the first 3D image (90) on the projection surface (18), wherein the second 3D image (92) comprises a first partial image for a right eye of a second viewer of the second 3D image (92) and a second partial image for a left eye of the second viewer of the second 3D image (92), the projector (10) comprising:
a third illumination arrangement (110), which generates a third illumination beam (112) depending on third image data, which are representative of the first partial image of the second 3D image (92), wherein the third illumination beam (112) comprises electromagnetic radiation having a predefined third property, which differs from the first and second properties;
a fourth illumination arrangement (114), which generates a fourth illumination beam (116) depending on fourth image data, which are representative of the second partial image of the second 3D image (92), wherein the fourth illumination beam (116) comprises electromagnetic radiation having a predefined fourth property, which differs from the first, second and third properties;
wherein the deflection device (16, 45) deflects the third and fourth illumination beams (112, 116) toward the projection surface (18) such that the third illumination beam (112) generates a third beam spot on the projection surface (18) and the fourth illumination beam (116) generates a fourth beam spot on the projection surface (18), wherein the third beam spot is moved over the projection surface (18) such that the first partial image of the second 3D image (92) is represented with the aid of the third beam spot, and the fourth beam spot is moved over the projection surface (18) such that the second partial image of the second 3D image (92) is represented on the projection surface (18) with the aid of the fourth beam spot.
